(19) United States
(12) Patent Application Publication
(10) Pub. No.: US 2024/0307809 A1
(43) Pub. Date: Sep. 19, 2024

(54) FILTER CARTRIDGE COMPRISING A PLURALITY OF FILTER ELEMENTS

(71) Applicant: Carl Freudenberg KG, Weinheim (DE)

(72) Inventors: Thorsten SCHMITT, Weinheim (DE); Sascha SCHUMACHER, Wald-Michelbach (DE); Stefan KLUCK, Reilingen (DE)

(21) Appl. No.: 18/599,407

(22) Filed: Mar. 8, 2024

(30) Foreign Application Priority Data
Mar. 16, 2023 (EP) 23 162 230.9

(51) Int. Cl. B01D 46/12; B01D 27/14

(52) U.S. Cl. CPC B01D 46/12; B01D 27/14

(57) ABSTRACT

A filter cartridge for cleaning an air flow, including a bottom, a cover arranged at a distance from the bottom, and a filter medium disposed between the bottom and the cover. A plurality of filter elements are arranged between the bottom and the cover. Each filter element is formed by a tube-shaped filter medium. The cover is provided with a plurality of openings.

### CROSS REFERENCE TO RELATED APPLICATIONS

This application claims benefit to European Patent Application No. EP 23 162 230.9, filed on Mar. 16, 2023, which is hereby incorporated by reference herein.

### FIELD

The invention relates to a filter cartridge comprising a plurality of filter elements, and to a space air cleaner comprising such a filter cartridge. The invention also relates to a space air cleaner comprising a filter cartridge.

### BACKGROUND

In many fields of engineering, filter cartridges are used, for example to clean intake air or exhaust air, and to prevent particulate from passing into blowers, fans, turbomachinery or the like. An air to be cleaned passes through filter cartridges. Often, filter cartridges are used as particulate removal filters. A filter cartridge is described, for example, in U.S. Pat. No. 11,369,907 B2. The arrangement of a plurality of filter cartridges can be derived, for example, from U.S. Pat. No. 8,580,004 B1. Filter cartridges are also used in space air cleaners, which are deployed by users in the household, in the industry and in spaces accessible to the general public to improve space air quality.

The filtration performance of such filter cartridges is limited by the effective filter surface. If the filter surface is to be increased, in accordance with the state of the art, a plurality of filter cartridges are used which are arranged in parallel to each other. A drawback of this is that each of the filter cartridges has to be individually inserted into the filter assembly and has to be individually replaced at the end of its useful life cycle. This causes not insubstantial effort for the users and also involves contacting the contaminated cartridges.

### SUMMARY

In an embodiment, the present disclosure provides a filter cartridge for cleaning an air flow, comprising a bottom, a cover arranged at a distance from the bottom, and a filter medium disposed between the bottom and the cover. A plurality of filter elements are arranged between the bottom and the cover. Each filter element is formed by a tube-shaped filter medium. The cover is provided with a plurality of openings.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIGS. 1a and 1b schematically show an embodiment of a filter cartridge in a perspective view;

FIGS. 2a to 2c schematically show an embodiment of a filter cartridge in simplified sectional views;

FIG. 2d schematically shows an embodiment of a filter cartridge in a perspective view;

FIGS. 3a and 3b schematically show an embodiment of a filter cartridge in a perspective view and in a view without the cover;

FIGS. 4a and 4b schematically show an embodiment of a filter cartridge in a perspective view and in a view without the cover; and

FIG. 5 schematically shows a filter cartridge in accordance with the state of the art.

### DETAILED DESCRIPTION

In an embodiment, the present invention provides a filter cartridge having improved filtration performance without having to change the structural space required by the filter cartridge or without negative effects on its efficiency.

According to an embodiment of the invention, it has been found advantageous to provide a filter cartridge with a plurality of filter elements.

The filter cartridge is for cleaning an air flow and includes a closed bottom, a cover provided with openings and at least one, in particular pleated, filter element arranged between the cover and the bottom. The filter element envelops an internal space of the filter cartridge. Air to be cleaned can flow from outside of the filter cartridge through the filter medium into the interior space and is thereby cleaned. According to an embodiment of the invention, a plurality (n=2, 3, 4, . . . ) of filter elements are arranged between the bottom and the cover, wherein each filter element is formed by a tube-shaped filter medium and each filter medium of each filter element envelops an internal space. The cover is provided with a same plurality (n=2, 3, 4 . . . ) of openings, wherein an opening is associated with each filter element and forms the outflow region of each filter element. By providing a plurality of filter elements in the filter cartridge the effective surface of the filter cartridge and thus its filtration performance can be increased. At the same time, rapid exchange of the filter cartridge is still facilitated.

In an embodiment of the filter cartridge, it includes at least three filter elements (n=3, 4 . . . ). Three or more filter elements can better utilize the available structural space of a filter cartridge than only two filter elements.

In an embodiment that is particularly advantageous from a manufacturing point of view, all of the filter elements of the filter cartridge have the same cross-section. Manufacturing and assembly processes can be simplified and different types of filter element need not be provided.

In an advantageous embodiment of the filter cartridge, all or at least some of the filter elements are configured as cylindrical tubes. These are particularly easily implemented from a manufacturing point of view by welding or adhesively gluing a pleated filter medium at both of its end pleats. Alternatively, tube segments are also provided, i. e. tubes, which have the shape of a segment of a circle when viewed from above, e. g., a third of a circle or a semicircle. In the case of thirds of circles, preferably, three identical filter elements, in the case of semicircles, preferably two identical filter elements, can be provided, since this ensures optimal utilization of the structural space.

In an advantageous embodiment of the filter cartridge, all or at least some of the filter elements are configured as conical tubes, which have a smaller diameter at one end and a larger diameter at the other end, thus have a frustoconical shape. These can also be provided with cylindrical tubes. Particularly advantageously, conical tubes of different orientation are combined with each other. This means that the smaller diameter of the conical tubes can be situated either in the region of the bottom or in the region of the cover of the filter cartridge. Due to this combination, space utilization can be optimized.

In an embodiment of this filter cartridge, the bottom and the cover—as viewed from above—have a circular configuration. Filter elements can be arranged in the form of cylindrical and/or conical tubes within the space defined by the bottom and the cover of the filter cartridge, so that the space is particularly well utilized. If the circular discs of the cover and the bottom have the same diameter, a cylindrical space is defined thereby, in which the filter elements are disposed.

Particularly good space utilization can be achieved with a filter cartridge having filter elements symmetrically arranged with respect to a center axis of the filter cartridge. To implement this, the filter elements can be arranged, for example, in a circle around the center axis. A central filter element can also be arranged in the center of the circle about the center axis itself. This can further increase the available filtration surface.

In a preferred embodiment, the external surfaces of the filter media of the plurality of filter elements are spaced from each other. The term spaced means a space of at least 2 mm or of at least 2 percent of the diameter or of the cross-section of a filter element. Such an arrangement has the advantage that each filter element can be exposed to the flow from all sides and thus the external surfaces of each filter medium are completely exposed to the flow and can be used for filtration. In the case of a configuration of the filter element as a cylindrical tube, the angle of their circumference over which they can be exposed to the flow is 360°.

The filter media of the filter cartridge can be pleated, thus provided with a zig-zag pleat. This can further increase the effective filtration surface.

In an embodiment, the cover of the filter cartridge has a plurality of Venturi nozzles, and the Venturi nozzles are in engagement with the pleated filter elements. Engagement, in this context, does not mean that the Venturi nozzle is inserted in the internal space of the filter element, but rather, that the Venturi nozzle and the filter element transition one into the other. This advantageous embodiment achieves that the cover through which the air flow can flow in the region of its opening, is configured to be as large as possible. In the concrete sense this means that the surface area able to be flown through is configured to be as large as possible. This advantageous guiding of the air flow can help to reduce the pressure losses provided by the present constricted diameters. Lower pressure losses are accompanied by an increase in the energy efficiency of the filter cartridge. In other words: by increasing the energy efficiency of the filter cartridge, energy can be saved. Such a configuration is shown and described in more detail in EP 3 680 003 B1.

In an embodiment of the filter cartridge according to the invention, its filter elements have been shaped as straight or oblique frusto-cones and have an oval shape, an essentially round or circular base in cross-section perpendicular to the longitudinal axis of the filter cartridge.

In an embodiment of the above-described filter cartridge, its filter elements can be sealed with respect to and fixedly connected to the cover and/or the bottom by a sealing compound, e. g. polyurethane PUR.

An embodiment of the invention also relates to a space air cleaner comprising a filter cartridge as described above.

The above-described embodiments of the invention, also in combination with each other—as far as this is technically feasible-represent advantageous embodiments of the invention.

Embodiments of the invention will be explained in more detail with reference to the accompanying drawing figures. Corresponding elements and components have been provided with the same reference numerals in the figures. To achieve better clarity in the figures, the drawings are not to scale.

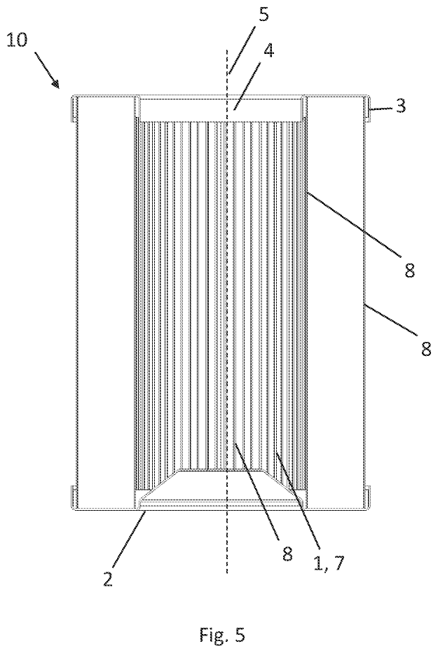

FIG. 5 shows a filter cartridge 10 in accordance with the state of the art. A single pleated filter element 1 is arranged between a bottom 2 and a cover 3 having a central recess (opening) 4, the pleated filter element 1 enveloping an internal space 6 of the filter cartridge 10. In the embodiment shown, the filter cartridge 10 has a cylindrical shape and the single filter element 1 is also configured to have a cylindrical shape. The perspective view of FIG. 5 shows a sectional view along the vertical longitudinal axis of the filter cartridge 10 so that both the pleats 8 of the filter element 1 and the pleat sections, i. e. the surfaces situated between two pleat folds, are clearly shown.

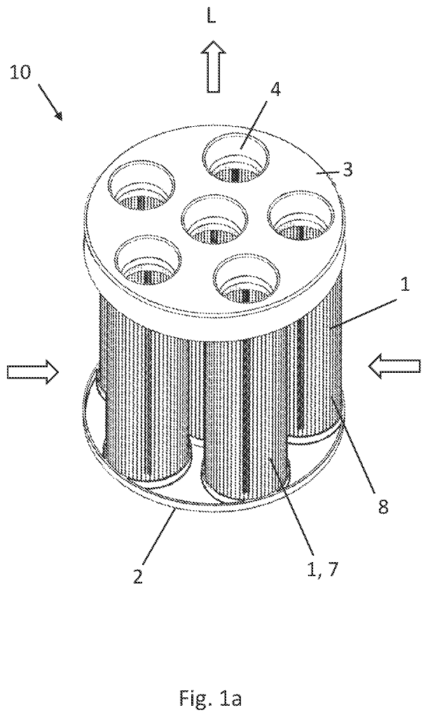

FIGS. 1a and 1b show a first embodiment of a filter cartridge in a perspective view and in a sectional view.

The filter cartridge 10 includes a bottom 2 and a cover 3. Both have a circular shape in the exemplary embodiment shown, i. e. the shape of a circular disc. Five cylindrical filter elements 1 are arranged between the bottom 2 and the cover 3. Each filter element 1 is formed by a pleated filter medium 7, i. e., a filter medium provided with pleats 8. A first filter element 1 is arranged at the center. The filter medium 7 thereof envelops the center axis of the filter cartridge 10. Four further filter elements 1 are situated around this filter element 1. They are symmetrically arranged with respect to the center axis 5 extending through the filter cartridge 10.

Openings 4 are provided in the cover 3, wherein each opening 4 is associated with a filter element 1. Air L to be cleaned, which passes through the filter media 7, is cleaned thereby and passes into the interior space of the filter elements 1, can flow out again through these openings 4 in the cover 3.

To illustrate the arrangement of a plurality of filter elements 1 in the filter cartridge 10, it is shown in a sectional view (horizontal sectional view) in FIG. 1b.

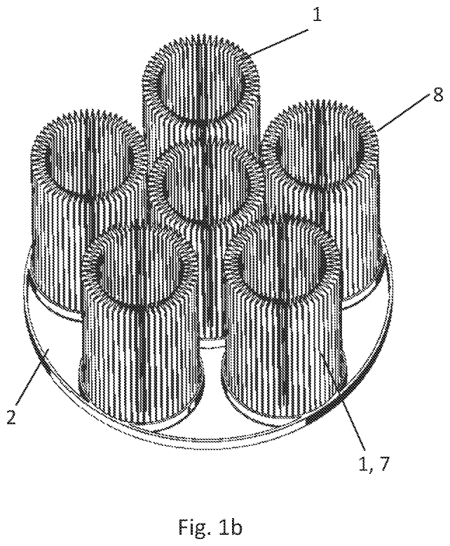

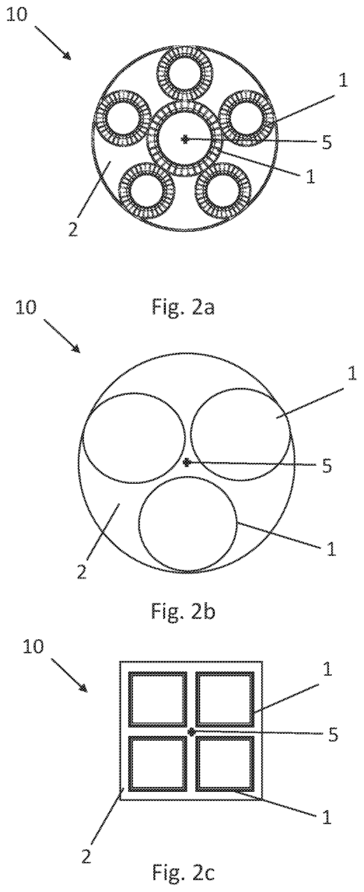

FIGS. 2a to 2c show alternative embodiments of a filter cartridge 10 in analogous sectional views in a simplified view.

In the filter cartridge 10 of FIG. 2a, five filter elements 1 are symmetrically arranged about a central filter element 1. The central filter element 1 has a larger diameter in comparison to the others.

In the filter cartridge 10 of FIG. 2b, three filter elements 1 are symmetrically arranged about a center axis 5. The external surfaces of the filter media 7 of the filter elements 1 are spaced from each other. Each filter element 1 can thus have an air flow L applied to it from all sides.

In the filter cartridge 10 of FIG. 2c, four filter elements 1 having square cross-sections are arranged in two rows and two columns about a center axis 5. Both the bottom 2 and the cover 3 also have square configurations and are thus configured as square plates.

FIG. 2d shows a further alternative embodiment of a filter cartridge 10 in a perspective view. The filter cartridge 10 includes a bottom 2 and a cover 3. Both have a circular shape in the exemplary embodiment shown, i. e., the shape of a circular disc. Six conical filter elements 1 are arranged, for example, between the bottom 2 and the cover 3. Each filter element 1 is formed by a pleated filter medium 7, i. e. a filter medium provided with pleats. A first filter element 1 is arranged in the center, which has a smaller diameter in the region of the cover 3. Its filter medium 7 envelops the middle axis of the filter cartridge 10. Five further filter elements 1 are disposed, for example, about this filter element 1. They are symmetrically arranged with respect to the middle axis 5 extending through the filter cartridge 10 and have a reversed orientation: their smaller diameters are at the level of the bottom 2.

Openings 4 are provided in the cover 3, wherein each opening 4 is associated with a filter element 1. Air L to be cleaned, which passes through the filter media 7, is cleaned thereby, and passes into the interior space of the filter elements 1, can flow out again through these openings 4 in the cover 3.

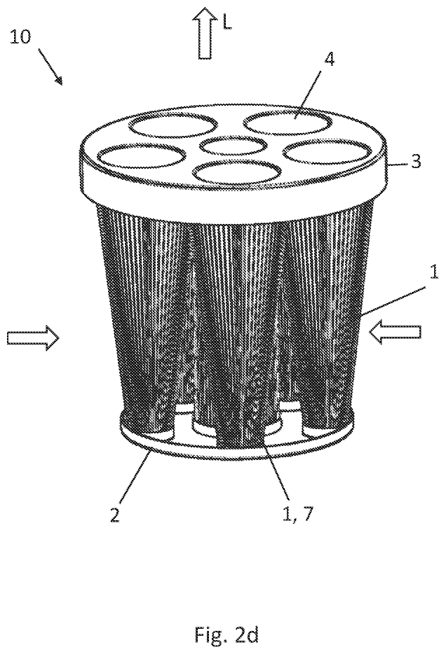

FIGS. 3a and 3b show a further embodiment of a filter cartridge 10 comprising three filter elements 1 in a perspective view and a view without the cover 3. The filter elements 1, in the top view, have the approximate shape of circular segments.

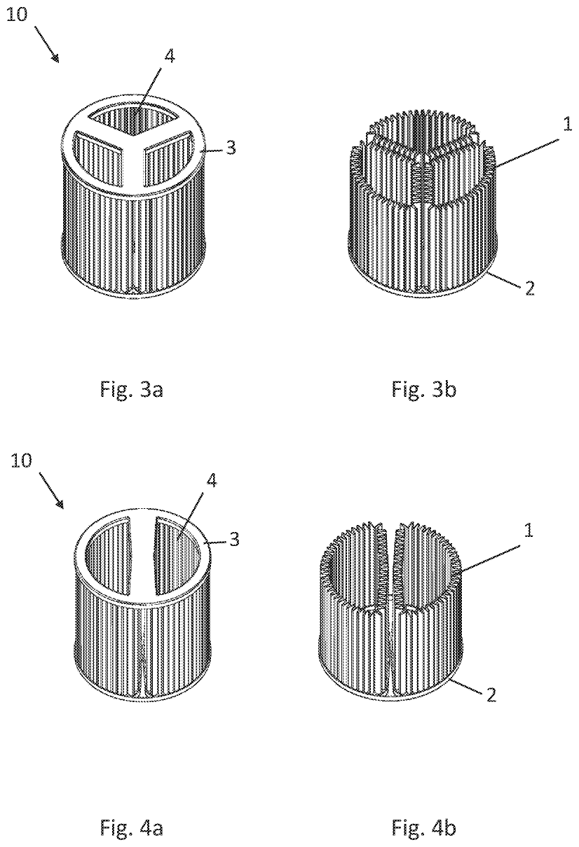

FIGS. 4a and 4b show a further embodiment of a filter cartridge 10 comprising two filter elements 1 in a perspective view and in a view without the cover 3. The filter elements 1, as viewed from above, have the approximate shape of semicircles.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

1 filter element
2 bottom
3 cover
4 opening (recess)
5 center axis
6 internal space
7 filter medium
8 pleats of filter element
9 -
10 filter cartridge
L air flow

1. A filter cartridge for cleaning an air flow, comprising:
a bottom;
a cover arranged at a distance from the bottom; and
a filter medium disposed between the bottom and the cover,
wherein a plurality of filter elements are arranged between the bottom and the cover,
wherein each filter element is formed by a tube-shaped filter medium, and
wherein the cover is provided with a plurality of openings.

2. The filter cartridge according to claim 1, wherein the filter cartridge includes at least three filter elements.

3. The filter cartridge according to claim 1, wherein all the filter elements have the same cross-section.

4. The filter cartridge according to claim 1, wherein one or more of the filter elements are formed as cylindrical tubes.

5. The filter cartridge according to claim 1, wherein one or more of the filter elements are formed as conical tubes.

6. The filter cartridge according to claim 4, wherein the bottom and the cover have a circular configuration when viewed from above.

7. The filter cartridge according to claim 1, wherein the filter elements are symmetrically arranged about a center axis extending through the filter cartridge.

8. The filter cartridge according to claim 1 wherein external surfaces of the filter media of the filter elements are spaced from each other.

9. The filter cartridge according to claim 1, wherein the filter media are pleated.

10. A space air cleaner comprising the filter cartridge according to claim 1.

11. The filter cartridge according to claim 5, wherein the bottom and the cover have a circular configuration when viewed from above.
